(19) United States
(12) Patent Application Publication
(10) Pub. No.: US 2024/0343088 A1
(43) Pub. Date: Oct. 17, 2024

(54) VENTILATION DEVICE FOR A VEHICLE VENTILATION, HEATING AND/OR AIR-CONDITIONING SYSTEM

(71) Applicant: Valeo Systemes Thermiques, Le Mesnil-Saint-Denis (FR)

(72) Inventors: Fabrice Ailloud, Le Mesnil-Saint-Denis (FR); Bruno Demory, Le Mesnil-Saint-Denis (FR); Mohamed Alaoui Benzakroum, Le Mesnil-Saint-Denis (FR); Manuel Henner, Le Mesnil-Saint-Denis (FR)

(73) Assignee: Valeo Systemes Thermiques, Le Mesnil-Saint-Denis (FR)

(21) Appl. No.: 18/292,105

(22) PCT Filed: Jul. 26, 2022
(86) PCT No.: PCT/EP2022/070972

§ 371 Date: Jan. 25, 2024

(30) Foreign Application Priority Data
Jul. 26, 2021 (FR) FR2108060

(51) Int. Cl. B60H 1/00; F04D 29/42; F04D 29/44

(52) U.S. Cl. CPC B60H 1/00471; B60H 1/00021; F04D 29/4253; F04D 29/444; B60H 2001/00092

(57) ABSTRACT

A ventilation device for a ventilation, heating, and/or air-conditioning system of a vehicle is disclosed. The ventilation device includes at least one housing that includes at least one housing that includes at least one wall contributing to the definition of an inner volume in which at least one radial propeller and one guide member are received. The radial propeller is configured to be rotated about an axis of rotation. The radial propeller includes a plurality of blades, each of which is at least delimited by a first axial end and a second axial end. The guide member includes a plurality of vanes delimited at least by a leading and trailing edge. The radial propeller and guide member are configured to force the circulation of an air flow through the housing along the axis of rotation between an air inlet opening and an air outlet opening.

The present invention relates to the field of ventilation, heating and/or air-conditioning systems intended to be incorporated into vehicles, and more particularly to the ventilation devices incorporated into such systems.

Vehicles conventionally comprise a ventilation, heating and/or air-conditioning system intended to thermally treat an air flow directed into a passenger compartment of this vehicle. These ventilation, heating and/or air-conditioning systems comprise at least one casing, in which at least one heat exchanger and at least one ventilation device are received. For example, a heat transfer fluid, that is a fluid capable of collecting, carrying and delivering heat energy, circulates in this heat exchanger. An air flow also passes through this heat exchanger and in so doing undergoes a change in temperature before being directed into the passenger compartment so as to thermally treat the volume thereof.

In order to generate the air flow capable of passing through the heat exchanger, the ventilation, heating and/or air-conditioning system conventionally comprises at least one ventilation device that comprises at least one propeller accommodated in a housing, this propeller being rotated by a movement member that can also be accommodated in the housing. The ventilation devices that are currently implemented comprise an axial air inlet, that is an opening that allows the air flow to enter the ventilation device in a direction parallel, or substantially parallel, to an axis of rotation of the propeller of this ventilation device, and a radial air outlet where the air flow exits in a direction radial to the propeller. In other words, such a ventilation device is conventionally arranged in a volute so that the air flow enters the ventilation device in a first direction and exits this housing in a second direction perpendicular to the first direction.

The propeller of such a ventilation device conventionally comprises a central body from which a plurality of blades extends radially. The plurality of blades is able to rotate about the direction of rotation and forces the circulation of the air flow through the ventilation device. The air flow then passes through a guide member configured to convey the circulation of the air flow toward an air outlet of the housing.

One drawback of these ventilation devices is that they have a particularly large footprint due to the radial nature of the air flow exiting the device. They cannot therefore be easily installed in particularly confined ventilation systems. In addition, these ventilation devices are known to be noisy and can inconvenience the driver and/or the passengers present in the passenger compartment of the vehicle.

In this context, the present invention proposes a new design of ventilation device with a radial propeller so that it occupies less space than the designs of the prior art. The invention also aims to improve both the energy output necessary to rotate the propeller and the acoustics produced by the ventilation device.

To this end, the main object of the present invention is a ventilation device for a ventilation, heating and/or air-conditioning system of a vehicle, comprising at least one housing that comprises at least one wall contributing to the definition of an inner volume in which at least one radial propeller and one guide member are received, the radial propeller being configured to be rotated about an axis of rotation, the radial propeller comprising a plurality of blades each of which is at least delimited by a first axial end and a second axial end, the guide member comprising a plurality of vanes at least delimited by a leading edge and a trailing edge, the radial propeller and the guide member being configured to force the circulation of an air flow through the housing along the axis of rotation between an air inlet opening and an air outlet opening of the ventilation device, characterized in that a height of the guide member measured along a direction parallel to the axis of rotation between a first plane passing through the leading edge of the plurality of vanes and a second plane passing through the trailing edge of the plurality of vanes represents at least 50% of a dimension measured between a third plane perpendicular to the axis of rotation and passing through at least one end of the plurality of blades closest to the guide member and a fourth plane perpendicular to the axis of rotation and containing the air outlet opening.

In other words, a first height is measured between the leading edge and the trailing edge of the plurality of vanes along a direction parallel to the axis of rotation, a second height being measured between the end of the plurality of blades of the radial propeller closest to the guide member and the air outlet opening along a direction parallel to the axis of rotation, the first height representing at least 50% of the second height.

The first plane, the second plane, the third plane, and the fourth plane extend parallel to each other and perpendicular to the axis of rotation.

“Radial propeller” is given to mean a propeller in which the air flow enters in a first direction, in this case parallel to the axis of rotation of this propeller, and exits in a second direction transverse, for example perpendicular, to the axis of rotation of this propeller. In other words, the radial propeller, within the meaning of the invention, comprises an axial air inlet and a radial air outlet.

The shape of the housing of this ventilation device and the shape of the air flow guide member received in this ventilation device together make it possible to channel the air flow generated by the rotation of the radial propeller so that the overall footprint of this ventilation device is reduced compared to the ventilation devices of the prior art. The air outlet of the ventilation device according to the invention thus can be placed in the axial extension of the radial propeller, which makes it possible to reduce the radial footprint of such a device. As a result, the ventilation device according to the invention can be more easily installed inside small vehicles, such as for example vehicles that are at least partly electrically powered.

The ventilation device according to the invention makes it possible to obtain even distribution of the air flow over the entire surface of the outlet opening formed in the wall of the housing, by tilting the air flow so that it meets the part of the outlet opening through which the axis of rotation of the radial propeller passes.

According to one optional feature of the invention, the plurality of vanes is fixed and rigidly connected to the wall of the housing. It will be understood that the plurality of vanes is not rotated about the axis of rotation and retains the same position in order to guide the air flow toward the air outlet opening and toward the axis of rotation of the radial propeller.

According to another optional feature of the invention, the height of the guide member is between 60 and 85 mm. Preferably, the height of the guide member is approximately 70 mm, plus or minus 1 mm.

According to another optional feature of the invention, the height of the guide member represents between 60 and 65% of the dimension measured between the third plane passing through the end of the plurality of blades closest to the guide member and the fourth plane containing the air outlet opening. Preferably, the height of the guide member represents approximately 63%, plus or minus 1%, of the dimension measured between the third plane passing through the end of the plurality of blades closest to the guide member and the fourth plane containing the air outlet opening.

According to another optional feature of the invention, at least two successive vanes are at least partially superposed, along a direction parallel to the axis of rotation of the radial propeller. It will be understood thereby that a portion of a first vane at least partially overlaps a portion of the second vane succeeding the first vane, and that the overlapping portions of the vanes are aligned along a direction parallel to the axis of rotation.

According to another optional feature of the invention, the ventilation device comprises at least one air filter having an air inlet that is contained in an inlet plane of the air flow parallel to the plane containing the air outlet opening of said ventilation device. It will be understood that the inlet plane of the air flow into the air filter and the plane containing the air outlet opening are substantially parallel, that is, the planes can be tilted with respect to each other at an angle of at most 2°.

According to another optional feature of the invention, the ventilation device comprises at least one air filter having an inlet that is contained in an inlet plane of the air flow coincident with the plane containing the air outlet opening of said ventilation device.

According to another optional feature of the invention, the ventilation device comprises at least one heat exchanger having an air inlet that is contained in an inlet plane of the air flow parallel to the plane containing the air outlet opening of said ventilation device. It will be understood that the inlet plane of the air flow into the heat exchanger and the plane containing the air outlet opening are substantially parallel, that is, the planes can be tilted with respect to each other at an angle of at most 2°.

According to another optional feature of the invention, the ventilation device comprises at least one heat exchanger having an inlet that is contained in an inlet plane of the air flow coincident with the plane containing the air outlet opening of said ventilation device.

According to another optional feature of the invention, the guide member comprises a bowl around which a plurality of vanes is evenly positioned, at least one vane of the plurality of vanes comprising a front side and a back side each extending between a proximal end of the vane in contact with the bowl and a distal end of the vane in contact with the wall of the housing.

According to another optional feature of the invention, the ventilation device comprises a motor for driving the radial propeller held by the bowl of the guide member.

According to another optional feature of the invention, a dimension measured between the proximal end and the distal end of the vane grows increasingly between the leading edge and the trailing edge.

According to one example of the invention, a distance measured between the proximal end and the distal end of a vane at its leading edge is smaller than a distance measured between the proximal end and the distal end of this vane at its trailing edge.

According to another optional feature of the invention, the vane has a first portion, a second portion, and a third portion aligned in that order from the proximal end toward the distal end, the vane comprising at least one transverse cross-section, viewed in a plane perpendicular to a radial direction of the axis of rotation, contained along a camber line between the leading edge and the trailing edge, this camber line being different in each of the first, second, and third portions of the vane.

It will be understood from the above that the vane extends along different camber lines depending on the portion in which the vane extends.

According to another optional feature of the invention, a first radius measured between the axis of rotation and the first portion along a direction radial to the axis of rotation is between 75 and 85 mm, a second radius measured between the axis of rotation and the second portion measured along a direction radial to the axis of rotation is between 85 and 95 mm, and a third radius measured between the axis of rotation and the third portion measured along a direction radial to the axis of rotation is between 100 and 110 mm.

According to another optional feature of the invention, the camber line followed by the vane in each portion is contained in a circle, a first angle being formed between a tangent to the circle passing through the leading edge and a direction passing through the leading edge and contained both in a plane perpendicular to the axis of rotation and in a plane containing the circle, the first angle having a value of between 17° and 23° in the first portion, a value of between 14° and 19° in the second portion, and a value of between 10° and 15° in the third portion.

According to another optional feature of the invention, the camber line followed by the vane in each portion is contained in a circle, a second angle being formed between a tangent to the circle passing through the trailing edge and a direction passing through the trailing edge and contained both in a plane perpendicular to the axis of rotation and in a plane containing the circle, the second angle having a value of between 95° and 100° in the first portion, a value of between 105° and 110° in the second portion, and a value of between 112° and 117° in the third portion.

A further object of the invention is a ventilation, heating and and/or air-conditioning system for a vehicle, comprising at least one ventilation device according to any one of the preceding features.

Further features, details and advantages of the invention will become more clearly apparent from reading the following description and a number of exemplary embodiments given by way of non-limiting illustration, with reference to the appended schematic drawings, in which:

FIG. 1 is a perspective depiction of a ventilation device according to one embodiment of the invention;

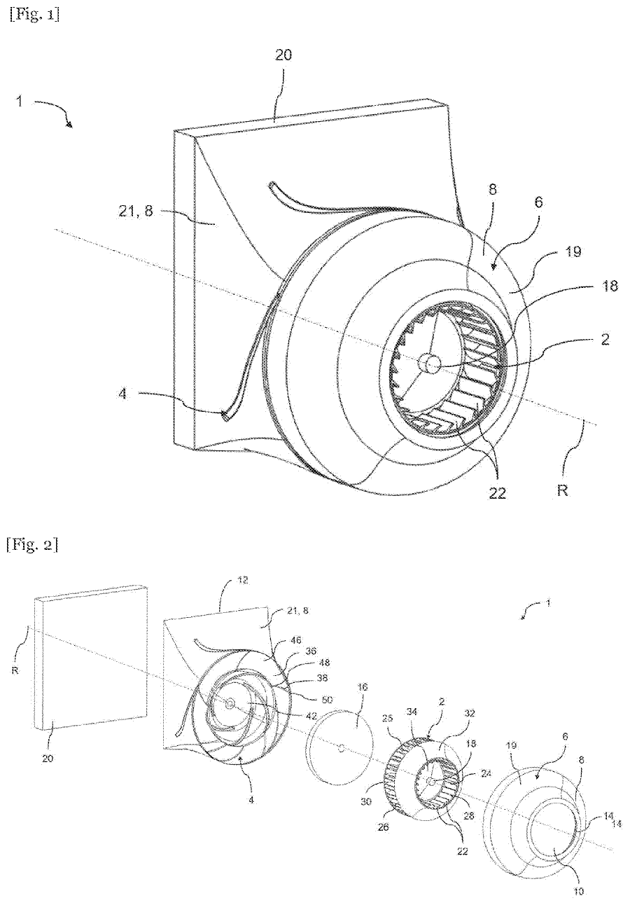

FIG. 2 is an exploded view of the ventilation device depicted in FIG. 1;

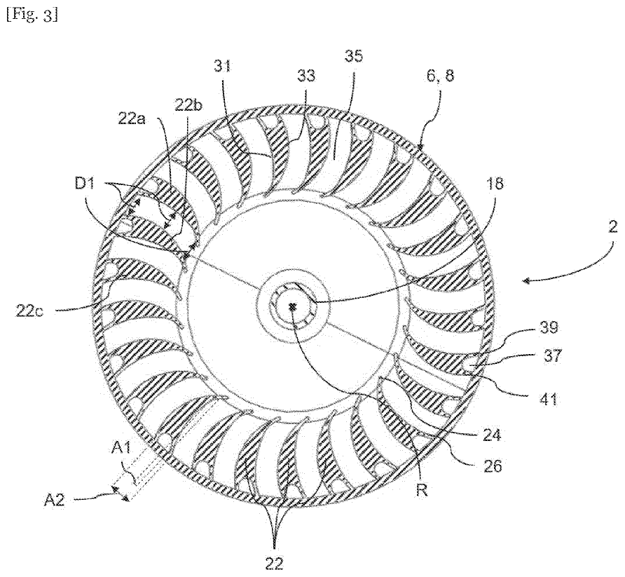

FIG. 3 is a cross-section of a radial propeller of the ventilation device depicted in FIG. 1, taken in a plane perpendicular to the axis of rotation of the radial propeller;

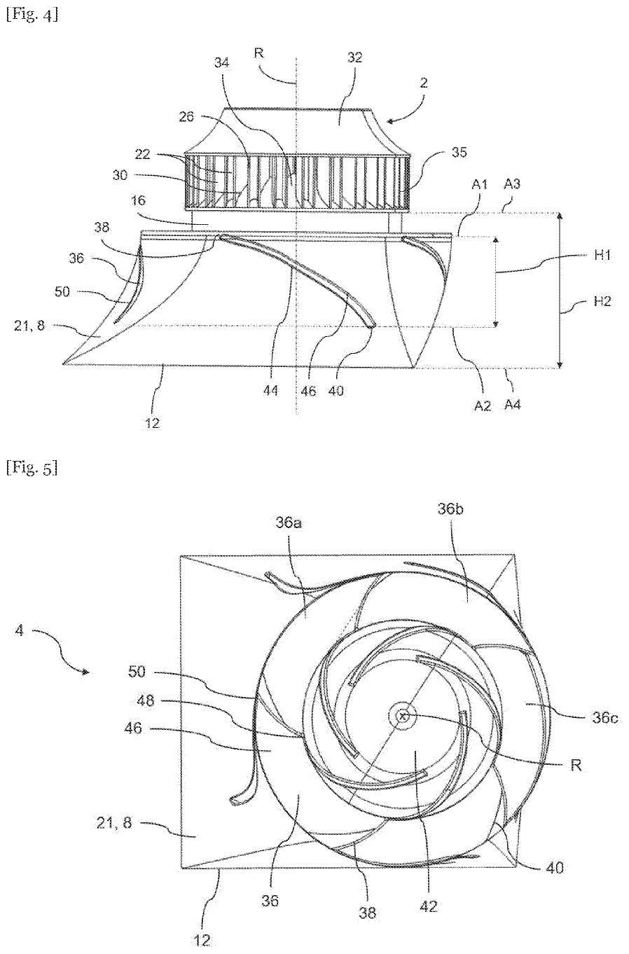

FIG. 4 is a perspective depiction of a side view of a radial propeller, a drive motor and the guide member of the ventilation device depicted in FIG. 1;

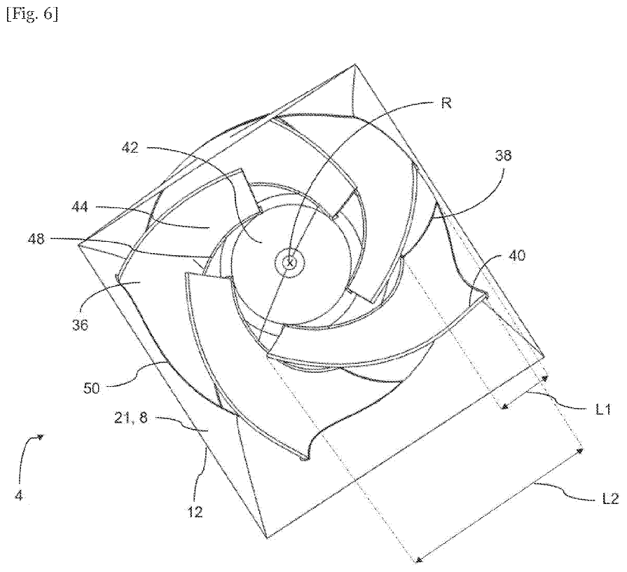

FIG. 5 is a perspective depiction of a top view of the guide member depicted in FIG. 4;

FIG. 6 is a perspective depiction of a bottom view of the guide member depicted in FIG. 4;

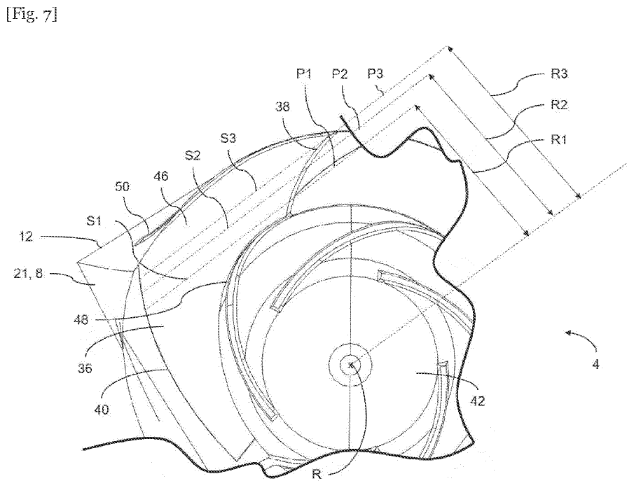

FIG. 7 is a perspective depiction of a detail view of a vane of the guide member depicted in FIG. 4;

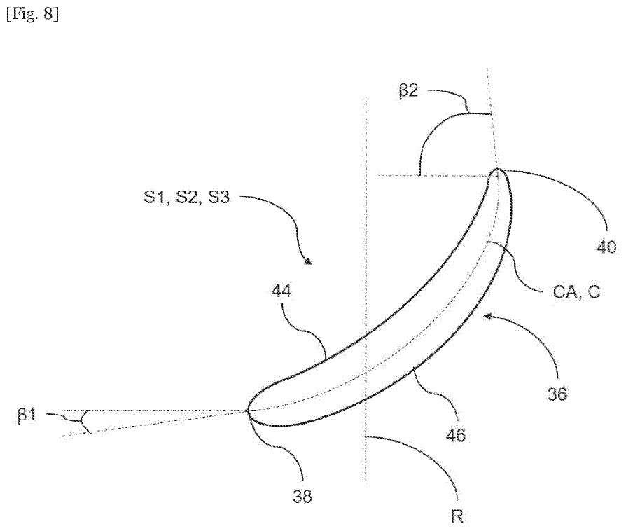

FIG. 8 is a cross-section of the vane depicted in FIG. 7.

The features, variants and different embodiments of the invention may be combined with one another, in various combinations, provided that they are not mutually incompatible or mutually exclusive. In particular, it is possible to envisage variants of the invention that comprise only a selection of features described below, independently of the other features described, if this selection of features is sufficient to confer a technical advantage and/or to differentiate the invention from the prior art.

In addition, the terms “upstream” and “downstream” used hereinafter in the description refer to the direction of circulation of an air flow through the ventilation device.

FIGS. 1 and 2 show a ventilation device 1 according to one embodiment of the invention comprising at least one radial propeller 2, a guide member 4 and a housing 6 in which the radial propeller 2 and the guide member 4 are accommodated.

As can be seen more particularly in FIG. 2, the housing 6 is at least made up of one wall 8 defining an inner volume 10 in which at least the radial propeller 2 is received. This type of ventilation device 1 is configured to be incorporated into a ventilation, heating and/or air-conditioning system in turn intended to be incorporated into a vehicle, for example an electrically powered vehicle, so as to thermally treat an air flow before it is directed into a passenger compartment of the vehicle. In other words, this air flow is used to cool or heat the passenger compartment of the vehicle. The ventilation device 1 according to the invention is configured to circulate the air flow through the ventilation, heating and/or air-conditioning system.

Advantageously, the guide member 4 is arranged axially between an air outlet opening 12 and the radial propeller 2. The ventilation device 1 is configured to rotate the radial propeller 2 about an axis of rotation R so as to generate the air flow, and the guide member 4, together with at least part of the wall 8 of the housing 6, contributes to straightening the air flow so that the air flow has a general direction of movement, between an air inlet opening 14 of the ventilation device 1 and the air outlet opening 12 of the ventilation device 1, parallel to the axis of rotation R of the radial propeller 2.

More specifically, the ventilation device 1 comprises a motor 16 for driving the radial propeller 2 about the axis of rotation R. The drive motor 16 is positioned axially between the guide member 4 and the radial propeller 2. For example, the drive motor 16 can be an electric motor that comprises at least one stator and at least one rotor, the rotor being rotatably connected to a shaft received in a hub 18 of the radial propeller 2. In other words, the axis of rotation R of the radial propeller 2 extends parallel to this hub 18 and passes through the center thereof.

The ventilation device 1 comprises at least one housing 6 in which at least the air inlet opening 14 and the air outlet opening 12 are formed. More specifically, the air inlet opening 14 is contained in a one plane and the air outlet opening 12 is contained in a plane substantially parallel to the plane containing the air inlet opening 14. More specifically, the air inlet opening 14 and the air outlet opening 12 are respectively formed in the wall 8 of the housing 6.

As illustrated in FIGS. 1 and 2, the ventilation device 1 comprises an air filter and/or a heat exchanger 20 arranged on the air outlet opening 12 of the ventilation device 1 so that the air flow passes at least partially through the air filter and/or heat exchanger 20. The air filter and/or heat exchanger 20 can partially close the air outlet opening 12, or advantageously completely close the air outlet opening 12. The air filter and/or heat exchanger 20 comprises at least one air inlet contained in a plane substantially parallel to the plane containing the air outlet opening 12 of the housing 6, the air inlet of the air filter and/or heat exchanger 20 being positioned facing the air outlet opening 12. “Substantially” is given to mean that an angle of 0 to 2° between the two planes is tolerated.

Preferably, the plane containing the air inlet of the air filter and/or heat exchanger 20 is coincident with the plane containing the air outlet opening 12 of the housing 6, the air flow being guided directly through the air filter and/or heat exchanger 20 downstream of the guide member 4 before circulating toward the passenger compartment of the vehicle.

The housing 6, and more specifically the wall 8 of this housing 6, is generally bell-shaped, that is, this housing 6 has a cross-section viewed in a plane perpendicular to the axis of rotation R of the radial propeller 2 the dimensions of which increase from the air inlet opening 14 toward the air outlet opening 12.

As mentioned above, the wall 8 of the housing 6 defines an inner volume 10 of the ventilation device 1, which houses at least the radial propeller 2 configured to generate the air flow and the guide member 4 configured to direct at least part of the air flow generated by the rotation of the radial propeller 2 toward the axis of rotation R of this radial propeller 2, after it has passed through the guide member 4. The radial propeller 2 is capable of being rotated by the drive motor 16 received in the ventilation device 1.

The housing 6 comprises at least one upper part 19, which houses the radial propeller 2, and a lower part 21, which houses the air flow guide member 4. For example, the upper part 20 and the lower part 21 of this housing 6 form two pieces of the housing 6 that interact with each other, that is, they are assembled to each other to form the housing 6 in a plane close to the guide member 4.

Furthermore, “radial propeller 2” is given to mean a propeller in which the air enters in a direction parallel to the axis of rotation R of this propeller and exits in a direction transverse to the axis of rotation R of the propeller. The axis of rotation R of the radial propeller 2 in the example illustrated is also parallel to a main extension axis of the housing 6.

In the remainder of the description, the terms “radial propeller 2” and “propeller 2” will be used interchangeably.

As can be seen in FIG. 2, the propeller 2 comprises a plurality of blades 22 each at least delimited by a first axial end 24 and a second axial end 26. The first axial end 24 of each blade 22 is oriented toward the axis of rotation R and the hub 18 of the propeller 2, while the second axial end 26 of each blade 22 is positioned opposite the first axial end 24 and contributes to the definition of a radial outlet 25 of the air flow. In addition, each blade 22 also comprises an upper line 28 and a lower line 30, each of these lines 28, 30 extending between the first axial end 24 and the second axial end 26. The upper line 28 of each blade 22 comprises a portion partially facing the air inlet opening 14 of the ventilation device 1, in particular near the first axial end 24, and another portion in contact with and rigidly connected to a covering wall 32 of the propeller 2 extending partially in a ring on the upper lines 28 of the plurality of blades 22. The lower line 30 of each blade 22 is in contact with and rigidly connected to a support 34 of the propeller 2 advantageously in the form of a bowl.

In addition, at least one blade 22 of the radial propeller 2 comprises a concave face 31 and a convex face 33 each extending along a direction parallel to the axis of rotation R between the lower line 30 and the upper line 28. Advantageously, each blade 22 of the radial propeller 2 comprises these concave faces 31 and convex faces 33 so that a concave face 31 of a blade 22 is facing a convex face 33 of a blade 22 succeeding said blade 22.

When the propeller 2 is rotated about the axis of rotation R, the plurality of blades 22 forces the circulation of the air flow from the air inlet opening 14 of the ventilation device 1, advantageously positioned on the upper part 19 of the housing 6, toward the radial outlet 25 for the air flow formed by the second axial ends 26 of the blades 22. In this configuration, the air flow circulates firstly along a direction substantially parallel to the axis of rotation R, then in a direction extending substantially radially from the axis of rotation R toward the radial outlet 25 of the propeller 2.

According to one embodiment of the invention, and as can be seen more particularly in FIG. 3, a thickness A1, A2 of at least one blade 22 of the radial propeller 2 measured along a direction perpendicular to the axis of rotation R grows from the first axial end 24 toward the second axial end 26 of this blade 22, a flow area 35 between at least two successive blades 22 of the radial propeller 2 being constant between two ends 24, 26.

More specifically and as illustrated in FIG. 3, a distance D1 between the concave face 31 of a first blade 22a of the radial propeller 2 and the convex face 33 of a second blade 22b succeeding this first blade 22a is constant between the first axial end 24 and the second axial end 26 of each of these two blades 22a, 22b. It will be understood that the distance D1 separating the concave face 31 of a blade 22 from the convex face 33 of the succeeding blade 22 is constant, that is it does not vary, along a direction radial to the axis of rotation R and along which the two blades 22 substantially extend.

In addition, and according to one example of the invention, the distance D1 measured between the upper lines 28 of two adjacent blades 22 is identical to a dimension measured between the lower lines 30 of these two successive blades 22. It will be understood that the distance D1 separating the concave face 31 of a blade 22 from the convex face 33 of the succeeding blade 22 is constant along a direction parallel to the axis of rotation R between the upper 28 and lower 30 lines of these two successive blades 22.

Advantageously, each flow area 35 for the air flow of the plurality of blades 22 of the radial propeller 2 has the same dimension. As a result, the dimensions of the flow area 35 that separates the concave face 31 of the first blade 22a from the convex face 33 of the second blade 22b are similar to the dimensions of a flow area 35 between the concave face 31 of the second blade 22b and the convex face 33 of a third blade 22c that immediately succeeds the second blade 22b. The blades 22 are thus evenly distributed around the hub 18.

In order to ensure a constant flow area 35 between the concave face 31 of a first blade 22 and the convex face 33 of a second blade 22, the thickness A1, A2 of each of these blades 22 tends to increase toward the second axial end 26 as one moves away from the first axial end 24. This thickness A1, A2 is measured, for each of the blades 22, along a direction perpendicular to a radius of the radial propeller 2 passing through the center of the blade 22, this direction also being perpendicular to the axis of rotation R of the radial propeller 2.

As can be seen more particularly in FIG. 3, it will be understood that the thickness of at least one blade 22 of the radial propeller 2 increases from the first axial end 24 of the blade 22 toward the second axial end 26 of this blade 22, the thickness being measured, it will be remembered, along a direction perpendicular to both a radius of the radial propeller 2 passing through the center of the blade 22 and the axis of rotation R.

It will thus be understood that a first thickness A1 measured at the first axial end 24 of the blade 22 has a smaller dimension than the dimension of a second thickness A2 of the blade 22 measured at the second axial end 26 of the blade 22. In addition, each of these thicknesses A1, A2 is measured between the concave face 31 and the convex face 33 of the blade 22.

As can be seen more particularly in FIG. 3, at least one blade 22 of the radial propeller 2 comprises a recess 37 in its second axial end 26, the recess 37 extending substantially over the entire thickness of the blade 22. In a preferred embodiment of the invention, each blade 22 of the radial propeller 2 comprises this recess 37.

Furthermore, the recess 37 has a U-shaped cross-section viewed in a plane perpendicular to the axis of rotation R. The blade 22 comprising a recess 37 thus comprises a first end 39 and a second end 41 that form the second axial end 26 of the blade 2, the first end 39 being positioned on the concave face 31 of said blade while the second end 41 is positioned on the convex face 33 of said blade. In this arrangement, the air flow would not circulate through the recess 37 in the blades 22. According to the example illustrated in FIG. 3, each blade 22 comprises the first end 39 and the second end 41.

The guide member 4 comprises a plurality of vanes 36 at least delimited by a leading edge 38 and a trailing edge 40 guiding the air flow circulated by the propeller 2 through the ventilation device 1 toward the axis of rotation R. It will be understood from this that the air stream, circulated by the propeller 2, is guided toward the air outlet opening 12 of the ventilation device 1 through the guide member 4, and that the plurality of vanes 36 recenters the circulation of the air flow toward the axis of rotation R, the air flow coming into contact with a vane 36 of the plurality of vanes 36 on its leading edge 38 and then circulating toward its trailing edge 40. To this end, the leading edge 38 of a vane 36 faces the propeller 2, while its trailing edge 40 faces the air outlet opening 12.

According to the example illustrated here in most of the figures, the plurality of vanes 36 comprises five vanes 36. However, a plurality of vanes 36 comprising at least two vanes 36 would not depart from the scope of the invention. Furthermore, a more detailed description of the vane 36 is given hereinafter in the description.

According to the invention and as can be seen in FIG. 4, a height H1 of the guide member 4 measured along a direction parallel to the axis of rotation R between a first plane A1 passing through the leading edge 38 of the plurality of vanes 36 and a second plane A2 passing through the trailing edge 40 of the plurality of vanes 36 represents at least 55% of a dimension H2 measured between a third plane A3 passing through the end of the plurality of blades 22 closest to the guide member 4 and a fourth plane A4 containing the air outlet opening 12. In other words, a first height H1 is measured along a direction parallel to the axis of rotation R between the leading edge 38 and the trailing edge 40 of the plurality of vanes 36, a second height H2 being measured along a direction parallel to the axis of rotation R between a corner formed between the lower line 30 and the second axial end 26 of the plurality of blades 22 and the air outlet opening 12 of the ventilation device 1, the first height H1 representing at least 50% of the second height H2. This ratio is necessary to optimize the guiding of the air flow by the guide member 4 from the propeller 2 toward the air outlet opening 12 and toward the axis of rotation R.

Preferably, the first height H1, thus corresponding to the height H1 of the guide member 4, represents between 60 and 65% of the dimension H2 measured between the third plane A3 passing through the end of the plurality of blades 22 closest to the guide member 4 and the fourth plane A4 containing the air outlet opening 12, the dimension H2 corresponding to the second height H2 defined above.

According to one exemplary embodiment of the invention, the height H1 of the guide member 4 is between 60 and 85 mm. The second height H2, measured between the corner formed between the lower line 30 and the second axial end 26 of the plurality of blades 22 and the air outlet opening 12 of the guide member, is between 90 and 135 mm.

More particularly, and as can be seen in FIGS. 2, 5, 6, and 7, the plurality of vanes 36 is fixed and rigidly connected to the wall 8 of the housing 6. It will be understood from the above that the plurality of vanes 36 is not rotated about the axis of rotation R and remains in position in order to guide the air flow toward the air outlet opening 12 and toward the axis of rotation R.

More particularly, the guide member 4 comprises a bowl 42 around which the plurality of vanes 36 is evenly positioned. This bowl 42, as can be seen in FIG. 2, is centered with respect to the axis of rotation R, that is, the axis of rotation R passes through the center of the bowl 42. Furthermore, at least part of the motor 16 for driving the propeller 2 is accommodated in this bowl 42.

At least one vane 36 of the plurality of vanes 36 comprises a front side 44 and a back side 46 each extending between a proximal end 48 of the vane 36 in contact with the bowl 42 and a distal end 50 of the vane 36 in contact with the wall 8 of the housing 6. It will be understood that the proximal end 48 is positioned as close as possible to the axis of rotation R, while the distal end 50 is positioned opposite it, each of these two ends 48, 50 extending between the leading edge 38 and the trailing edge 40 of the vane 36.

Furthermore, the front side 44 of a first vane 36a is facing the back side 46 of a second successive vane 36b, the front side 44 of the second vane 36b facing the back side 46 of a third vane 36c succeeding the second vane 36b.

Preferably, each of the vanes 36 comprises a leading edge 38, a trailing edge 40, a front side 44, a back side 46, a proximal end 48 and a distal end 50 as described above. Furthermore, the description of one feature of one of the vanes 36 of the plurality of vanes 36 hereinafter in the description also applies for the other vanes 36 of the plurality of vanes 36 unless stated otherwise.

According to the invention and as can be seen more particularly in FIG. 6, a dimension measured between the proximal end 48 and the distal end 50 of the vane 36 grows increasingly between the leading edge 38 and the trailing edge 40. In other words, the proximal end 48 and the distal end 50 of the vane 36 tend to move away from each other as one moves away from the leading edge 38 and closer to the trailing edge 40 along a direction parallel to the axis of rotation R.

A first width L1 of the vane 36 can also be defined, measured between the proximal end 48 and the distal end 50 of the vane 36 on its leading edge 38, and a second width L2 measured between the proximal end 48 of the vane 36 and the distal end 50 of the vane 36 on its trailing edge 40, the first width L1 being less than the second width L2.

According to one feature of the invention and as can be seen more particularly in FIG. 5, at least two successive vanes 36 are at least partially superposed, along a direction parallel to the axis of rotation R of the radial propeller. It will be understood that at least one portion of the first vane 36a is superposed with a portion of the second vane 36b along a direction parallel to the axis of rotation R, one of the two portions hiding the other portion when the guide member 4 is observed from the top or from the bottom. To make the invention easier to understand, the portion of the second vane 36b superposed on the first vane 36a is shown by dashes in FIG. 5.

More specifically, the superposed portions of the first vane 36a and the second vane 36b are situated near the proximal end 48 of each of the vanes 36. In addition, the portion of the first vane 36a superposed on the portion of the second vane 36b is situated on the leading edge 38 of the first vane 36a, while the portion of the second vane 36b superposed on the portion of the first vane 36a is situated on the trailing edge 40 of the second vane 36b.

FIGS. 7 and 8 show a transverse cross-section of a first portion S1 of one of the vanes 36, a transverse cross-section of a second portion S2 of the same vane 36 and a transverse cross-section of a third portion S3 of this vane 36, the S2 of the same vane 36 and a and a transverse cross-section of a third portion S3 off this vane 36. Furthermore, the transverse cross-section of the first portion S1 is taken in a transverse plane P1 situated a first distance R1 from the axis of rotation R passing through the center of the guide member 4, the transverse cross-section of the second portion S2 being taken in a transverse plane P2 situated a second distance R2 from the axis of rotation R passing through the center of the guide member 4, and the transverse cross-section of the third portion S3 is taken in a transverse plane P3 situated a third distance R3 from the axis of rotation R passing through the center of the guide member 4. The first transverse plane P1, the second transverse plane P2 and the third transverse plane P3 are each perpendicular with respect to a radial direction of the axis of rotation R.

More specifically, the first distance R1 measured between the first transverse plane P1 and the axis of rotation R is between 75 and 85 mm, this first distance R1 being the smallest distance measured between the first transverse plane P1 and the axis of rotation R. Advantageously, this first distance R1 is approximately 78 mm.

The second distance R2 measured between the second transverse plane P2 and the axis of rotation R is between 85 and 95 mm, this second distance R2 being the smallest distance measured between the second transverse plane P2 and the axis of rotation R. Advantageously, this second distance R2 is approximately 90 mm. The third distance R3 measured between the third transverse plane P3 and the axis of rotation R is between 100 and 110 mm, this third distance R3 being the smallest distance measured between the third transverse plane P3 and the axis of rotation R. Advantageously, this third distance R3 is approximately 105 mm.

In each of these portions S1, S2, S3, the vane 36 extends along a camber line CA between its leading edge 38 and its trailing edge 40, this camber line CA being different in each of the first, second, and third portions S1, S2, S3 of the vane 36. It will be understood that in each of these portions S1, S2, S3, the vane 36 does not extend in one plane. The camber line CA followed by the vane 36 in each portion S1, S2, S3 is contained in a circle C. In other words, the vane 36 extends along a camber line CA contained in a different circle C in each portion S1, S2, S3.

According to the invention, a first angle β1 is formed between a tangent to the circle passing through the leading edge 38 and a direction passing through the leading edge 38 and contained both in a plane perpendicular to the axis of rotation R and in a plane containing the circle C, the first angle β1 having a value of between 17° and 23° in the first portion S1, a value of between 14° and 19° in the second portion S2, and a value of between 10° and 15° in the third portion S3. Preferably, the first angle β1 has a value of approximately 20° in the first portion S1, approximately 17° in the second portion S2, and approximately 13° in the third portion S3.

According to the invention, a second angle β2 is formed between a tangent to the circle passing through the trailing edge 40 and a direction passing through the trailing edge 40 and contained both in a plane perpendicular to the axis of rotation R and in a plane containing the circle C, the second angle β2 having a value of between 95° and 100° in the first portion S1, a value of between 105° and 110° in the second portion S2, and a value of between 112° and 117° in the third portion S3. Preferably, the second angle β2 has a value of approximately 98° in the first portion S1, approximately 109° in the second portion S2, and approximately 115° in the third portion S3.

The present invention is not however limited to the means and configurations described and illustrated herein, and it also extends to all equivalent means and configurations and to any technically effective combination of such means. In particular, the number of vanes 36 of the plurality of vanes 36 can vary without departing from the scope of the invention, provided that the guide member 4 continues to guide the air flow toward the air outlet opening 12 and the axis of rotation R.

1. A ventilation device for a ventilation, heating and/or air-conditioning system of a vehicle, the ventilation device comprising:
at least one housing that comprises at least one wall contributing to the definition of an inner volume in which at least one radial propeller and one guide member are received,
wherein the radial propeller is configured to be rotated about an axis of rotation,
the radial propeller comprising a plurality of blades, each of which is at least delimited by a first axial end and a second axial end,
the guide member comprising a plurality of vanes at least delimited by a leading edge and a trailing edge,
wherein the radial propeller and the guide member are configured to force the circulation of an air flow through the housing along the axis of rotation between an air inlet opening and an air outlet opening of the ventilation device,
wherein a height of the guide member measured along a direction parallel to the axis of rotation between a first plane passing through the leading edge of the plurality of vanes and a second plane passing through the trailing edge of the plurality of vanes represents at least 50% of a dimension measured between a third plane perpendicular to the axis of rotation and passing through at least one end of the plurality of blades closest to the guide member and a fourth plane perpendicular to the axis of rotation and containing the air outlet opening.

2. The ventilation device as claimed in claim 1,
wherein the plurality of vanes is fixed and rigidly connected to the wall of the housing.

3. The ventilation device as claimed in claim 1,
wherein the height of the guide member is between 60 and 85 mm.

4. The ventilation device as claimed in claim 1,
wherein the height of the guide member represents between 60 and 65% of the dimension measured between the third plane passing through the end of the plurality of blades closest to the guide member and the fourth plane containing the air outlet opening.

5. The ventilation device as claimed in claim 1,
wherein at least two successive vanes are at least partially superposed, along a direction parallel to the axis of rotation of the radial propeller.

6. The ventilation device as claimed in claim 1, further comprising at least one air filter,
wherein the air filter comprises an air inlet that is contained in an inlet plane of the air flow parallel to the plane containing the air outlet opening of the ventilation device.

7. The ventilation device as claimed in claim 1, further comprising at least one heat exchanger,
wherein the heat exchanger comprises an air inlet that is contained in an inlet plane of the air flow parallel to the plane containing the air outlet opening of the ventilation device.

8. The ventilation device as claimed in claim 1,
wherein the guide member comprises a bowl around which a plurality of vanes is evenly positioned,
wherein at least one vane of the plurality of vanes comprises a front side and a back side each extending between a proximal end of the vane in contact with the bowl and a distal end of the vane in contact with the wall of the housing.

9. The ventilation device as claimed in claim 8,
further comprising a motor for driving the radial propeller held by the bowl of the guide member.

10. The ventilation device as claimed in claim 8,
wherein a dimension measured between the proximal end and the distal end of the vane grows increasingly between the leading edge and the trailing edge.

11. The ventilation device as claimed in claim 9,
wherein the vane comprises a first portion, a second portion, and a third portion aligned in that order from the proximal end toward the distal end,
the vane comprising at least one transverse cross-section, viewed in a plane perpendicular to a radial direction of the axis of rotation, contained along a camber line between the leading edge and the trailing edge,
wherein the camber line is different in each of the first, second, and third portions of the vane.

12. The ventilation device as claimed in claim 11,
wherein a first radius measured between the axis of rotation and the first portion along a direction radial to the axis of rotation is between 75 and 85 mm,
wherein a second radius measured between the axis of rotation and the second portion measured along a direction radial to the axis of rotation is between 85 and 95 mm, and
wherein a third radius measured between the axis of rotation and the third portion measured along a direction radial to the axis of rotation is between 100 and 110 mm.

13. The ventilation device as claimed in claim 11,
wherein the camber line followed by the vane in each portion is contained in a circle,
wherein a first angle is formed between a tangent to the circle passing through the leading edge and a direction passing through the leading edge and contained both in a plane perpendicular to the axis of rotation and in a plane containing the circle,
wherein the first angle has a value of between 17° and 23° in the first portion, a value of between 14° and 19° in the second portion, and a value of between 10° and 15° in the third portion.

14. The ventilation device as claimed in claim 11,
wherein the camber line followed by the vane in each portion is contained in a circle,
wherein a second angle is formed between a tangent to the circle passing through the trailing edge and a direction passing through the trailing edge and contained both in a plane perpendicular to the axis of rotation and in a plane containing the circle,
wherein the second angle has a value of between 95° and 100° in the first portion, a value of between 105° and 110° in the second portion, and a value of between 112° and 117° in the third portion.

15. A ventilation, heating and and/or air-conditioning system for a vehicle, the system comprising at least one ventilation device as claimed in claim 1.
